(19) United States
(12) Patent Application Publication
(10) Pub. No.: US 2025/0352422 A1
(43) Pub. Date: Nov. 20, 2025

(54) WEARABLE DEVICE FOR ASSISTING LOWER BODY MOTION AND CONTROL METHOD THEREOF

(71) Applicant: Electronics and Telecommunications Research Institute, Daejeon (KR)

(72) Inventor: Ho Chul SHIN, Daejeon (KR)

(73) Assignee: Electronics and Telecommunications Research Institute, Daejeon (KR)

(21) Appl. No.: 19/207,707

(22) Filed: May 14, 2025

(30) Foreign Application Priority Data
May 20, 2024 (KR) 10-2024-0065336
Jan. 16, 2025 (KR) 10-2025-0006599

(51) Int. Cl. A61H 3/00; A61H 1/02

(52) U.S. Cl. CPC A61H 3/00; A61H 1/0262; A61H 2003/007; A61H 2201/14; A61H 2201/1642; A61H 2201/1652; A61H 2201/5007; A61H 2201/5061; A61H 2230/625

(57) ABSTRACT

A wearable device for assisting a lower body motion and a control method thereof are disclosed. According to an embodiment of the present disclosure, there is provided a wearable device that assists a motion of a lower body by an elastic force, the wearable device includes: a plurality of straps for engaging a body of a user; a plurality of elastic frames configured to be elastically deformed according to a motion of the user, and configured to include an upper elastic frame extending from one side of a waist of the user to one side of a knee of the user and a lower elastic frame extending from one side of a thigh of the user to one side of an ankle of the user; and a plurality of elastic members, wherein each elastic member of the plurality of elastic members includes: at least one of a strap of the plurality of straps, the upper elastic frame, and the lower elastic frame.

### CROSS-REFERENCE TO RELATED APPLICATION

The present application claims the benefit under 35 USC § 119 of Korean Patent Application No. 10-2024-0065336 filed on May 20, 2024 and Korean Patent Application No. 10-2025-0006599 filed on Jan. 16, 2025, in the Korean Intellectual Property Office, the entire disclosures of which are incorporated herein by reference for all purposes.

### BACKGROUND

### Technical Field

The present disclosure relates to a wearable device for assisting a lower body movement and a control method thereof.

### Background of the Invention

The content described in this part merely provides background information for the present disclosure, but does not constitute the prior art.

Wearable suits are high-tech equipment in the form of being worn on the body of a human user. The wearable suits mainly perform a function of supporting or assisting a motion of a user by using a sensor, an actuator, a communication module, and the like.

The wearable suits are similar to an exoskeleton robot technology, and is mainly used for the purpose of supplementing a physical limit of a human or improving work efficiency.

The wearable suits utilize various sensors to sense user motion and analyze sensing data to assist in the user's motion.

For example, industrial wearable suits that support heavy objects motions reduce the burden on lower body muscles and waist regions, amplify the user's forces, and assist in easily lifting heavy objects.

Wearable suits for medical and rehabilitation purposes assist patients with weakened bodies in walking or moving.

Conventional wearable suits are mostly expensive equipment, and have a disadvantage that when they are manufactured according to a special purpose and perform an activity other than the special purpose, the activity is rather reduced.

Accordingly, there is a need for a device and a method that may effectively assist a user's lower body motion without compromising activity using the resilient force of the component itself.

### SUMMARY

### Contents of the Invention

### Problem to be Solved

Accordingly, the present disclosure is intended to solve these problems, and a main object thereof is to provide a wearable device that assists a motion of a lower body of a user.

The problems to be solved by the present invention are not limited to the above-mentioned problems, and other problems that are not mentioned will be clearly understood by those skilled in the art from the following description.

### Method for Solving Problem

According to one embodiment of the present disclosure to achieve these objectives, there is provided a wearable device that assists a motion of a lower body by an elastic force, the wearable device includes: a plurality of straps for engaging a body of a user; a plurality of elastic frames configured to be elastically deformed according to a motion of the user, and configured to include an upper elastic frame extending from one side of a waist of the user to one side of a knee of the user and a lower elastic frame extending from one side of a thigh of the user to one side of an ankle of the user; and a plurality of elastic members, wherein each elastic member of the plurality of elastic members includes: at least one of a strap of the plurality of straps, the upper elastic frame, and the lower elastic frame.

### Effects of the Invention

As described above, according to the present embodiment, the wearable device has an effect of being able to assist a motion of a user's lower body.

In addition, there is an effect of providing an auxiliary force to a lower body of a user to assist a sitting motion, a standing motion, a running motion, and a walking motion of the user.

### BRIEF DESCRIPTION OF THE DRAWINGS

FIG. 1 is a functional block diagram of a wearable device according to an embodiment of the present disclosure.

FIG. 2 is a perspective view illustrating when a user wearing a wearable device according to an embodiment of the present disclosure is standing.

FIG. 3 is a perspective view illustrating a front surface when a user wearing a wearable device according to an embodiment of the present disclosure is sitting.

FIG. 4 is a perspective view illustrating a rear surface when a user wearing the wearable device according to an embodiment of the present disclosure is sitting.

FIG. 5 is a flowchart illustrating a control method of a wearable device according to an embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing the components of the present invention, the terms “first,” “second,” “A,” “B,” “(a),” “(b),” and the like may be used. These terms are only used to distinguish the components from other components, and the nature, sequence, order, or the like of the components is not limited by these terms.

Where an element is described as being “connected,” “coupled” or “accessed” to another element, it will be understood that the element may be directly connected or accessed to the other element, but that another element may also be “connected,” “coupled” or “accessed” between each element.

Throughout the specification, when a part “includes” or “has” an element, unless otherwise specified, the part may further include other elements instead of excluding the other elements.

The terms “unit,” “module,” and the like described in the specification mean a unit that processes at least one function or motion, and may be implemented by hardware, software, or a combination of hardware and software.

Unless otherwise specified, it should be understood that the description of one embodiment may be applied to other embodiments.

The description set forth below in connection with the appended drawings is intended to describe exemplary embodiments of the invention and is not intended to represent the only embodiments in which the invention may be practiced.

The directions used in the present disclosure will be described. A direction is defined with reference to a state in which a human user according to the present disclosure stands upright.

In the present disclosure, the front is a direction in which the user's face looks, and coincides with a gaze direction when the user looks at the front.

In the present disclosure, the rear means a direction of the user's back. That is, the direction is opposite to the forward direction.

The front and back between each component may be defined relative to each other.

In the present disclosure, the left side means a left shoulder direction of the user. That is, it means the left side with respect to the body of the user.

In the present disclosure, the right side means a right shoulder direction of the user. That is, it means the right side with respect to the body of the user.

The left and right sides between each component may be defined relative to each other.

In the present disclosure, the downward means a direction of the ground with respect to the user.

In the present disclosure, the upward means in a direction opposite to the ground with respect to the user.

The downward and upward between each component may be defined relative to each other.

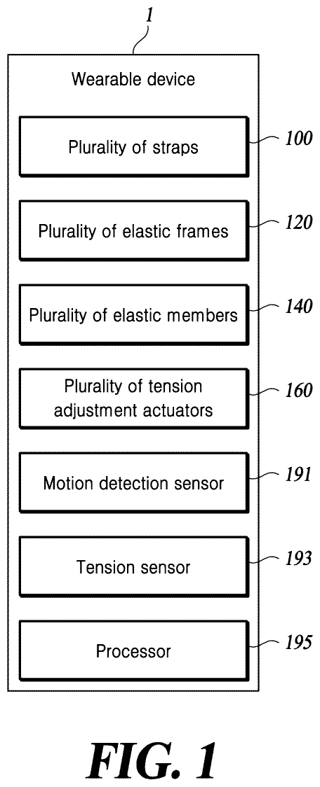

FIG. 1 is a functional block diagram of a wearable device according to an embodiment of the present disclosure.

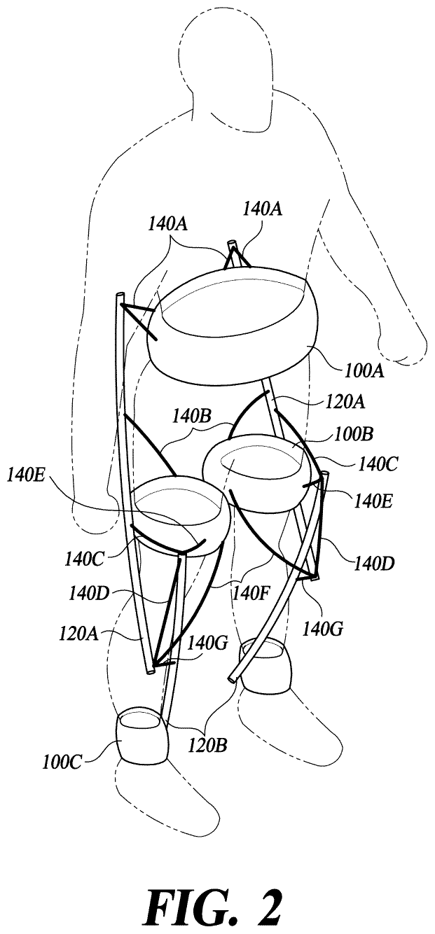

FIG. 2 is a perspective view illustrating when a user wearing a wearable device according to an embodiment of the present disclosure is standing.

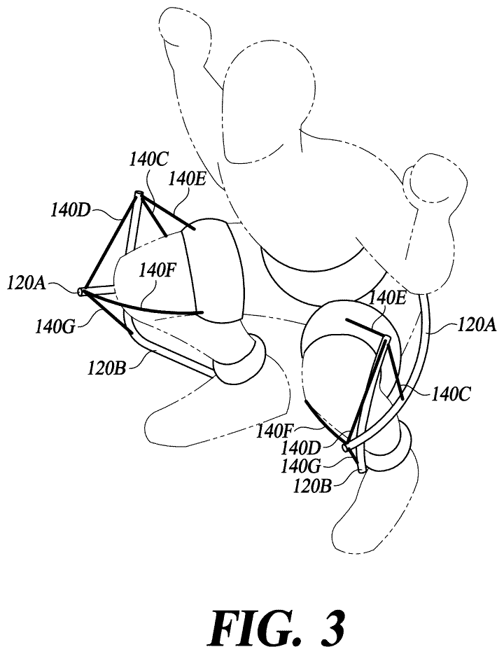

FIG. 3 is a perspective view illustrating a front surface when a user wearing a wearable device according to an embodiment of the present disclosure is sitting.

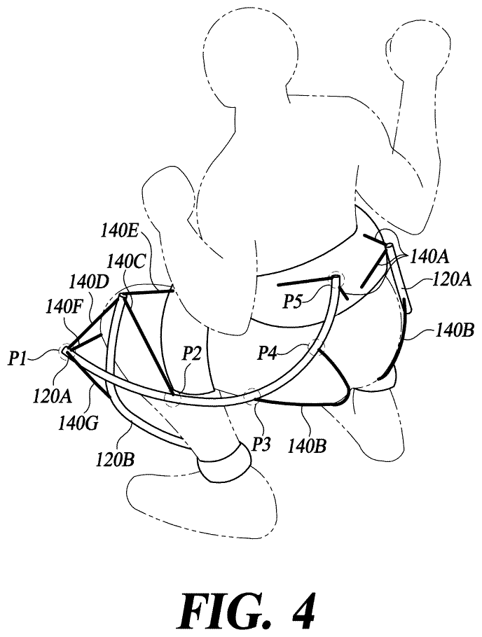

FIG. 4 is a perspective view illustrating a rear surface when a user wearing the wearable device according to an embodiment of the present disclosure is sitting.

Referring to FIG. 1 to FIG. 4, a wearable device 1 (hereinafter referred to as a “device”) based on an elastic structure that assists a motion of a lower body with an elastic force may include a plurality of straps 100, a plurality of elastic frames 120, a plurality of elastic members 140, a plurality of tension adjustment actuators 160, a motion detection sensor 191, a tension sensor 193, a processor 195, and the like.

The device 1 may be configured to assist in a motion of a lower body with an elastic force. The device 1 assists a motion of the user so as to be able to prevent injuries.

The device 1 assists a motion of the user so that the user may reliably perform the sitting motion. The device 1 prevents a stress concentration phenomenon so that a user is not injured when the user performs a sitting motion. When a sitting motion is performed without the device 1, a stress concentration phenomenon occurs in a joint of a user, and there is a risk of injury. On the other hand, when the user performs a sitting motion while wearing the device 1, a stress concentration phenomenon does not occur in a joint such as a knee, a hip joint, and an ankle of the user. This is because shocks and/or loads generated during the user's sitting motion are transmitted to the device 1 and accumulated as elastic energy.

The device 1 assists a motion of the user so that the user may stably perform a standing up motion. The device 1 prevents a stress concentration phenomenon so that a user is not injured when performing the motion in which the user stands up. When the motion of standing up without wearing the device 1 is performed, a stress concentration phenomenon occurs in a joint of the user, and there is a risk of injury. On the other hand, when performing the motion in which the user stands up while wearing the device 1, a stress concentration phenomenon does not occur in a joint such as a knee, a hip joint, and an ankle of the user. This is because the device 1 provides the user with the necessary energy and/or force when performing the motion of the user standing up. The device 1 provides accumulated elastic energy when the user performs a standing motion, thereby minimizing the load on the hip joint, knee, ankle, etc.

The plurality of straps 100 may be configured to engage a user's body. The plurality of straps 100 serve to support the plurality of elastic members 140 and the plurality of elastic frames 120. Specifically, the plurality of straps 100 are configured to withstand the tension generated by elastic deformation of the plurality of elastic members 140 and/or the plurality of elastic frames 120 according to the physical activity of the user. The strap 100 may be more than the number disclosed in the figures so as not to strain a particular body part of the user, e.g., the part where the strap 100 is worn.

The plurality of straps 100 may include at least one waist strap 100A configured to wrap around a user's waist, a pair of thigh straps 100B configured to wrap around the user's thighs, a pair of ankle straps 100C configured to wrap around an ankle of the user, and the like. The types of straps that the plurality of straps 100 may include are not limited by the examples described above. Each of the plurality of straps 100 disclosed in the figures is illustrative only. The shape, size, position, number, etc. of each of the plurality of straps 100 is not limited to the content disclosed in the drawings.

The plurality of straps 100 may vary in length in an elastic material. Specifically, the length may be adjusted to correspond to the body size of the user wearing the plurality of straps 100. The plurality of straps 100 are stretched or shrunk to correspond to the motion of the user wearing the plurality of straps, so as not to impair the activity of the user.

The plurality of elastic frames 120 may be configured to elastically deform according to motion of a user. The plurality of elastic frames 120 may be configured to engage with the plurality of elastic members 140. The plurality of elastic frames 120 provide a restoring force, and the restoring force acts as an external force that assists the motion and motion of the user.

The plurality of elastic frames 120 may include an upper elastic frame 120A, a lower elastic frame 120B, and the like. The upper elastic frame 120A and the lower elastic frame 120B are disposed to be spaced apart from each other, and the upper elastic frame 120B is disposed on top of the lower elastic frame.

According to an embodiment, the upper elastic frame 120A may be a pair.

The upper elastic frame 120A disposed on the right side of the pair may extend downward from the rear right side of the waist, and may extend to the right side of a right thigh, the right side of right knee, and a right side of right calf.

The upper elastic frame 120A disposed on the left side of the pair may extend downward from the rear left side of the waist, and may extend to the left side of a left thigh, the left side of left knee, and the left side of right calf.

When the user performs a motion of standing and sitting, the upper elastic frame 120A is elastically deformed to be bent, to accumulate elastic energy. Specifically, when the user stands and sits down, the upper elastic frame 120A bends convexly to the rear of the user and accumulates elastic energy. The upper elastic frame 120A absorbs impacts and loads generated when sitting to minimize loads applied to the hip joint, knee, and ankle of the user.

When the user performs a motion of sitting and standing up, the upper elastic frame 120A is elastically deformed to be unfolded in a bent state. Specifically, when the user sits down and stands up, the upper elastic frame 120A is unfolded according to a restoring force in a bent state, and provides a standing force to the user. That is, the elastic energy accumulated by the upper elastic frame 120A is used to assist the standing motion of the user. Since the standing force is provided from the upper elastic frame 120A, the user may stand up without using a large force when standing up. The upper elastic frame 120A absorbs impacts and loads generated when standing up to minimize loads applied to the hip joint, knee, and ankle of the user.

According to an embodiment, the lower elastic frame 120B may be a pair.

The lower elastic frame 120B disposed on the right side of the pair may extend downward from the front right side of the right thigh, and may extend to the front right of the right knee and the front left of the right ankle.

The lower elastic frame 120B disposed on the left side of the pair may extend downward from the front left side of the left thigh, and may extend to the front left of the left knee and the front right of the left ankle.

When the user performs a motion of standing and sitting, the lower elastic frame 120B is elastically deformed to be bent, to accumulate elastic energy. Specifically, when the user stands and sits down, the lower elastic frame 120B bends convexly to the front of the user and accumulates elastic energy. The lower elastic frame 120B absorbs shocks and loads generated when sitting to minimize loads applied to the hip joint, knee, and ankle of the user.

When the user performs a motion of sitting and then standing up, the lower elastic frame 120B is elastically deformed to be unfolded in a bent state. Specifically, when the user sits down and stands up, the lower elastic frame 120B unfolds according to a restoring force in a bent state, and provides a standing force to the user. That is, the elastic energy accumulated by the lower elastic frame 120B is used to assist the standing motion of the user. Since the standing force is provided from the lower elastic frame 120B, the user may stand up without using a large force when standing up. The lower elastic frame 120B absorbs impacts and loads generated when standing up to minimize loads applied to the hip joint, knee, and ankle of the user.

The types of elastic frames that the plurality of elastic frames 120 may include are not limited by the foregoing description and examples. Each of the plurality of elastic frames 120 disclosed in the figures is merely illustrative. The shape, size, position, number, and the like of each of the plurality of elastic frames 120 are not limited to the contents disclosed in the drawings.

The plurality of elastic members 140 may connect the plurality of straps 100 and the plurality of elastic frames 120.

Each elastic member of the plurality of elastic members 140 may be configured to engage with at least one or more of any one of the straps of the plurality of straps 100, the upper elastic frame 120A, and the lower elastic frame 120B.

The plurality of elastic members 140 may be wires having varying lengths. The lengths of the plurality of elastic members 140 change according to the motion of the user, and the tension changes according to the lengths. In addition, the plurality of elastic members 140 are coupled to the plurality of elastic frames 120 to adjust the restoring force of the plurality of elastic frames 120.

When each of the plurality of elastic frames 120 is bent and stretched as the user performs a standing and sitting motion, each of the plurality of elastic members 140 may be stretched and increased in tension.

When each of the plurality of elastic frames 120, which have been bent by a user performing a motion of standing up while sitting down, is unfolded, each of the plurality of elastic members 140 may be contracted to reduce tension.

The plurality of elastic members 140 may include a plurality of first elastic members 140A. One end of the plurality of first elastic members 140A is coupled to the upper end portion of the upper elastic frame 120A, and the other end thereof is coupled to the waist strap 100A.

The plurality of elastic members 140 may include a plurality of second elastic members 140B. One end of the plurality of second elastic members 140B is coupled to the central portion of the upper elastic frame 120A, and the other end thereof is coupled to the thigh strap 100B.

The plurality of elastic members 140 may include a plurality of third elastic members 140C. One end of the plurality of third elastic members 140C is coupled to the central portion of the upper elastic frame 120A, and the other end thereof is coupled to the upper end portion of the lower elastic frame 120B.

The plurality of elastic members 140 may include a plurality of fourth elastic members 140D. One end of the plurality of fourth elastic members 140D is coupled to the lower end portion of the upper elastic frame 120A, and the other end thereof is coupled to the upper end portion of the lower elastic frame 120B.

The plurality of elastic members 140 may include a plurality of fifth elastic members 140E. One end of the plurality of fifth elastic members 140E is coupled to the thigh strap 100B, and the other end thereof is coupled to the lower end portion of the upper elastic frame 120A.

The plurality of elastic members 140 may include a plurality of sixth elastic members 140F. One end of the plurality of sixth elastic members 140F is coupled to the thigh strap 100B, and the other end thereof is coupled to the lower end portion of the upper elastic frame 120A.

The plurality of elastic members 140 may include a plurality of seventh elastic members 140G. One end of the plurality of seventh elastic members 140G is coupled to the lower end portion of the upper elastic frame 120A, and the other end thereof is coupled to the central portion of the lower elastic frame 120B.

The plurality of elastic members 140 and the plurality of elastic frames 120 interact with each other to adjust the tension, so that the external force provided by the device 1 to the user is adjusted.

The types of elastic members that the plurality of elastic members 140 may include are not limited by the examples described above. Each of the plurality of elastic members 140 disclosed in the drawings is merely an example. The shape, size, position, number, and the like of each of the plurality of elastic members 140 are not limited to the contents disclosed in the drawings.

There may be a plurality of tension adjustment actuators 160. The tension adjustment actuator 160 may be provided in each of the plurality of elastic members 140, or may be provided in only a part of the plurality of the elastic members 140.

The tension adjustment actuator 160 serves to change the length of the elastic member 140. In this case, the elastic member 140 may be a wire having a varying length. According to the adjustment of the length of the elastic member 140 of the tension adjustment actuator 160, the tension of the elastic member 140 varies, and the external force acting on the body of the user varies.

The tension adjustment actuator 160 may be disposed between the elastic frame 120 and the elastic member 140. Each of the plurality of tension adjustment actuators 160 may engage either of the upper elastic frame 120A and the lower elastic frame 120B.

FIG. 4 shows the positions in which the tension adjustment actuators 160 may be arranged by imaginary circles P1 to P5 indicated by dashed lines. However, the virtual circles P1 to P5 indicated by the dashed lines in FIG. 4 are merely illustrative, and positions where the tension adjustment actuator 160 may be disposed are not limited to those in FIG. 4 (P1 to P5).

The tension adjustment actuator 160 may be disposed at any position capable of adjusting the length of the elastic member 140. For example, the tension adjustment actuator 160 may be disposed on the waist strap 100A (not shown).

The device 1 according to the present disclosure is provided with a plurality of tension adjustment actuator actuators 160, so that tension adjustment optimized for the motion of the user is possible.

The motion detection sensor 191 detects a motion/movement of the user and generates a signal. The motion detection sensor 191 may be disposed on at least one of the plurality of straps 100, the plurality of elastic frames 120, the plurality of the elastic members 140, and the plurality of the tension adjustment actuators 160. For example, the motion detection sensor 191 may be embedded in any one or more of the plurality of straps 100.

The motion detection sensor 191 may include an inertial sensor (inertial measurement unit, IMU, not shown), an electromyography sensor (not shown), or the like.

The inertial sensor may be located on any one or more of the plurality of straps 100. The inertial sensor include all or part of accelerometers, gyroscopes, and magnetometers. The inertial sensor may sense the user's motion/movement and generate a signal.

The electromyography sensor may be located on any one or more of the plurality of straps 100. The electromyography sensor may sense an electrical signal generated when a muscle contracts to generate a signal.

The tension sensor 193 may measure a tension with respect to each of the plurality of elastic members 140. The tension sensor 193 may be disposed on at least one of the plurality of straps 100, the plurality of elastic frames 120, the plurality of the elastic members 140, and the plurality of the tension adjustment actuators 160. For example, the tension sensor 193 may be embedded in any one or more of the plurality of straps 100.

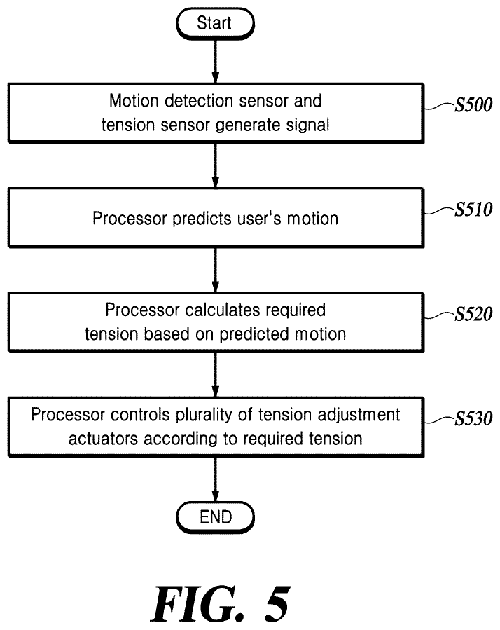

FIG. 5 is a flowchart illustrating a control method of a wearable device according to an embodiment of the present disclosure.

Referring to FIG. 5, the device 1 according to the present disclosure performs steps S500 to S530 to control the plurality of tension adjustment actuators 160 and assist the lower body motion of the user.

Specifically, when the user performs motion such as a walking motion, a standing motion, and a sitting motion, the motion detection sensor 191 and the tension sensor 193 generate a signal (S500).

The processor 195 may predict a motion of the user based on a signal of the motion detection sensor 191 and a signal of the tension sensor 193 (S510). The motion detection sensor 191 includes an inertial sensor, an electromyography sensor, and the like, and senses a motion of the user in real time to generate a signal. The tension sensor 193 measures the tension of each of the plurality of elastic members 140 that changes according to the motion of the user in real time to generate a signal. That is, the processor 195 may analyze signals received from the motion detection sensor 191 and the tension sensor 193 to grasp a current motion and posture of the user, and predict a next motion of the user.

The processor 195 may calculate a required tension required for each elastic member 140 of the plurality of elastic members 140 based on the predicted motion (S520).

In order to adjust the length of each elastic member 140 according to the calculated required tension, the processor 195 may control each of the plurality of tension adjustment actuators 160 (S530). The device 1 according to the present disclosure may adjust the length and the tension of each elastic member 140 in real time according to the required tension, so as to assist the user's motion in real time.

For example, when the user performs a sitting motion, the device 1 adjusts the length of each elastic member 140 according to a required tension, so as to provide a damping function so as not to burden a joint of the user.

For example, when the user performs a motion of standing up, the device 1 adjusts the length of each elastic member 140 according to a required tension, so as to provide a standing force that is a force for standing up, and reduce a load and a burden applied to a joint of the user.

For example, when the user walks or runs, the device 1 adjusts the length of each elastic member 140 according to the required tension, so as to provide an external force to facilitate the user to walk or run.

The device 1 according to the present disclosure may provide the required external force to the user according to various physical activities and motions of the user, in addition to the above-described examples, to assist the physical activities and the motions of the user.

Each component of the device or method according to the present disclosure may be implemented by hardware or software, or may be implemented by a combination of hardware and software. In addition, a function of each component may be implemented in software, and a microprocessor may be implemented to execute a function of the software corresponding to each component.

Various implementations of the systems and techniques described herein may be realized in digital electronic circuitry, integrated circuitry, field programmable gate arrays (FPGAs), application specific integrated circuits (ASICs), computer hardware, firmware, software, and/or combinations thereof. These various implementations may include implementation in one or more computer programs that are executable on a programmable system. The programmable system includes at least one programmable processor (which may be a special-purpose processor or may be a general-purpose processor) coupled to receive data and instructions from a storage system, at least one input device, and at least one output device, and to transmit data and instructions to them. Computer programs (also known as programs, software, software applications or code) include instructions for a programmable processor and are stored in a “computer readable recording medium”.

The computer-readable recording medium includes all kinds of recording devices in which data that may be read by a computer system is stored. Such a computer-readable recording medium may be a non-volatile or non-transitory medium such as a ROM, a CD-ROM, a magnetic tape, a floppy disk, a memory card, a hard disk, a magneto-optical disk, a storage device, or the like, and may further include a transitory medium such as a data transmission medium. In addition, the computer-readable recording medium may be distributed in a network-connected computer system, and the computer-readable code may be stored and executed in a distributed manner.

Although the flowchart/timing diagram of the present disclosure describes that the processes are executed sequentially, this is merely an example of the technical idea of an embodiment of the present disclosure. In other words, the flowcharts/timing diagrams are not limited to a chronological order, as those skilled in the art may make various modifications and variations to the sequence of the flowchart/timing diagram or to perform one or more of the processes in parallel without departing from the essential characteristics of the embodiments of the present disclosure.

The foregoing descriptions are merely illustrative of the technical concept of the present embodiment, and various modifications and variations may be made by those skilled in the art without departing from the essential characteristics of the present embodiment. Therefore, the present embodiments are not intended to limit the technical concept of the present embodiments, but are intended to be illustrative, and the scope of the technical concept of this embodiment is not limited by these embodiments. The protection scope of the present embodiment is to be construed according to the following claims, and all technical ideas within the scope equivalent thereto are construed as being included in the scope of rights of the present embodiment.

### DESCRIPTION OF SYMBOLS

1: Wearable device
100: Plurality of straps
120: Plurality of elastic frames
140: Plurality of elastic members
160: Plurality of tension adjustment actuators
191: Motion sensor
193: Tension sensor
195: Processor

What is claimed is:

1. A wearable device that assists a motion of a lower body by an elastic force, the wearable device comprising:
a plurality of straps for engaging a body of a user;
a plurality of elastic frames configured to be elastically deformed according to a motion of the user, and configured to include an upper elastic frame extending from one side of a waist of the user to one side of a knee of the user and a lower elastic frame extending from one side of a thigh of the user to one side of an ankle of the user; and
a plurality of elastic members,
wherein each elastic member of the plurality of elastic members comprises:
at least one of a strap of the plurality of straps, the upper elastic frame, and the lower elastic frame.

2. The wearable device of claim 1, further comprising:
a motion detection sensor that detects a motion of the user;
a tension sensor that measures tension of each of the elastic members;
a plurality of tension adjustment actuators provided for each elastic member to change a length of each elastic member; and
a processor that predicts a motion of the user based on a signal of the motion detection sensor and a signal of the tension sensor, calculates a required tension required for each elastic member based on the predicted motion, and controls each of the plurality of tension adjustment actuators to adjust a length of each elastic member according to the calculated required tension.

3. The wearable device of claim 2,
wherein the motion detection sensor is configured to be built into at least one of the plurality of straps.

4. The wearable device of claim 2,
wherein one end of each of the plurality of tension adjustment actuators is coupled to one of the upper elastic frame and the lower elastic frame.

5. The wearable device of claim 1,
wherein each of the plurality of elastic members is formed of a wire of varying length.

6. The wearable device of claim 1,
wherein each of the plurality of elastic frames is elastically deformed to be bent to accumulate elastic energy, when the user performs a motion of standing and sitting.

7. The wearable device of claim 6,
wherein each of the plurality of elastic frames generates a restoring force by using the elastic energy when the user performs a motion of sitting and standing up; and
wherein the restoring force acts as an external force that unfolds each of the plurality of bent elastic frames to assist the user in standing up.

8. The wearable device of claim 1,
wherein the plurality of elastic members comprise:
a plurality of first elastic members having one end coupled to an upper end portion of the upper elastic frame and the other end coupled to a waist strap.

9. The wearable device of claim 1,
wherein the plurality of elastic members comprise:
a plurality of second elastic members having one end coupled to a central portion of the upper elastic frame and the other end coupled to a thigh strap.

10. The wearable device of claim 1,
wherein the plurality of elastic members comprise:
a plurality of third elastic members having one end coupled to a central portion of the upper elastic frame and the other end coupled to an upper end portion of the lower elastic frame.

11. The wearable device of claim 1,
wherein the plurality of elastic members comprise:
a plurality of fourth elastic members having one end coupled to a lower end portion of the upper elastic frame and the other end coupled to an upper end portion of the lower elastic frame.

12. The wearable device of claim 1,
wherein the plurality of elastic members comprise:
a plurality of fifth elastic members having one end coupled to a thigh strap and the other end coupled to the lower end portion of the upper elastic frame.

13. The wearable device of claim 1,
wherein the plurality of elastic members comprise:
a plurality of sixth elastic members having one end coupled to a thigh strap and the other end coupled to the lower end portion of the upper elastic frame.

14. The wearable device of claim 1,
wherein the plurality of elastic members comprise:
a plurality of seventh elastic members having one end coupled to a lower end portion of the upper elastic frame and the other end coupled to a central portion of the lower elastic frame.
